(19) United States
(12) Patent Application Publication
(10) Pub. No.: US 2026/0302030 A1
(43) Pub. Date: Oct. 1, 2026

(54) ACTUATOR ARRANGEMENT AND VEHICLE ASSEMBLY WITH SUCH AN ACTUATOR ARRANGEMENT

(71) Applicant: Robert Bosch GmbH, Stuttgart (DE)

(72) Inventors: Alexander Fuchs, Kornwestheim (DE); Andreas Kaag, Vaihingen/Enz-Aurich (DE); Heiko Michel, Gerlingen (DE); Klaus Schudt, Nordheim (DE); Tilo Hofmann, Moeglingen (DE)

(21) Appl. No.: 18/880,513

(22) PCT Filed: Jun. 12, 2023
(86) PCT No.: PCT/EP2023/065579

§ 371 Date: Feb. 19, 2025

(30) Foreign Application Priority Data
Jul. 8, 2022 (DE) 10 2022 206 989.7

(51) Int. Cl. H01F 7/16

(52) U.S. Cl. CPC H01F 7/1607

(57) ABSTRACT

An actuator arrangement to be fastened to a unit. The actuator arrangement includes an electromagnetic actuator having at least one electrical coil and one armature which is mounted displaceably between a first position and a second position inside the coil, wherein the armature can be moved from the first position to the second position by means of energizing the electrical coil, a control device for controlling the electromagnetic actuator, and a fastener for fastening the electromagnetic actuator to the uni. The control device is arranged on the fastener. A vehicle assembly, including at least one such actuator arrangement and a unit, is also described.

### FIELD

The present invention relates to an actuator arrangement to be fastened to a unit, and to a vehicle assembly.

### BACKGROUND INFORMATION

Electromagnetic actuators can be used to control various functions. Such an actuator is described, for example, in European Patent No. EP 1 844 378 B1.

An electromagnetic actuator typically has an electromagnet connected to a control device. The control device can provide the voltage supply for the coil of the electromagnet. The control device is usually installed in the immediate vicinity of the electromagnet, as this ensures a short connection from the electromagnet to the control device and allows a compact design to be achieved.

In order to achieve the greatest possible actuating forces of the actuator, the highest possible actuating current or a correspondingly high voltage must be provided. This causes the control device and the electromagnet to heat up.

The disadvantage is that the control device and the electromagnet heat each other up and can exceed a permissible maximum temperature. To ensure that the maximum temperature is not exceeded, the electromagnet is operated at a lower actuating current or voltage, which leads to a lower actuating force of the actuator and therefore to a loss of performance.

### SUMMARY

According to the present invention, an actuator arrangement to be fastened to a unit is provided. The actuator arrangement comprises an electromagnetic actuator having at least one electrical coil (electromagnet) and an armature mounted displaceably (axially) between a first position and a second position inside the coil. The armature can be at least partially magnetic or ferromagnetic. The armature can be moved between the first position and the second position, in particular from the first position to the second position, by means of energizing the electrical coil, in particular due to magnetic interaction between the energized coil and the armature.

The actuator arrangement comprises a control device for controlling the electromagnetic actuator and, in particular, for energizing the electrical coil (or the electromagnet). The control device can be an “electronic control unit” (ECU) or an “electronic control module” (ECM).

The actuator arrangement has a fastening means (i.e., fastener) for fastening the electromagnetic actuator to the unit, wherein the control device is arranged on the fastening means (directly or indirectly).

The unit can be designed as a motor or transmission. The unit is in particular a heat sink for the actuator. In other words, the heat of the actuator arrangement can be transferred to the unit or dissipated via the unit. This allows the heat generated by the control device to flow away to the unit via the fastening means. In particular, this prevents the heat generated by the control device from dissipating toward the coil of the actuator and heating it up or vice versa. In other words, heat transfer between the coil and the control device is prevented or at least minimized.

The actuator can be designed as a (pure) electromagnet, as an electromagnetically operated slide valve or as an electromagnetically operated seat valve. The control device, the coil and/or the actuator can each be encapsulated, in particular encapsulated in plastics material. The control device can have at least three terminals for connecting to a vehicle assembly and at least two terminals for connecting to the actuator.

According to a development of the present invention, the fastening means can be designed as a spring clip, in particular a metal spring clip. The spring clip can have portions having different (sheet metal) thicknesses and/or having different materials. This means that the fastening means can be implemented using simple means.

According to a development of the present invention, the spring clip can have at least one spring arm, in particular two spring arms, for contacting the actuator. The spring clip can only contact the actuator via the spring arm(s). In particular, the spring clip does not contact the actuator outside the spring arm. The spring arm(s) can be designed as separate parts and welded or riveted to the spring clip. Alternatively, the spring clip can be formed in one piece overall. The spring clip can be punched or cut from sheet metal, for example by laser, and/or formed into its shape by working. The spring arm(s) can have a different (sheet metal) thickness than the rest of the spring clip and/or be made of a different material. For example, thin-walled, high-strength sheet metal can be used for the spring arm(s) (better spring properties), while thicker sheet metal could be used for the rest of the spring clip, which ensures better heat conduction.

According to a development of the present invention, the fastening means can have a contact surface and contact the actuator, in particular exclusively, by means of the contact surface. The contact surface can be continuous or can be formed from individual, a plurality of, in particular two, partial surfaces. The contact surface can be smaller than 10mm². The contact surface can be located on the spring arm(s). The fastening means can contact the actuator at the end (axial end) facing away from the unit, in particular at specific points. In particular, the fastening means contacts the actuator exclusively at the contact surface. In particular, the fastening means does not contact the actuator outside the contact surface. The relatively small contact surface ensures that heat transfer between the fastening means and the actuator is largely minimized.

According to a development of the present invention, the fastening means and the control device can be designed as a single assembly. The control device can be pre-mounted on the fastening means. The fastening means can be connected to the control device by means of an adhesive, screw and/or rivet connection, in particular in a form-fitting and/or force-fitting manner. This simplifies the handling of the control device and the fastening means (designed as a single assembly or in one piece).

According to a development of the present invention, the control device (or the assembly comprising the control device and the fastening means) can be connected (mechanically and/or electrically) to the actuator by means of a detachable connection, in particular by means of a snap-in, clip and/or plug connection. In particular, the control device contacts the actuator exclusively via the detachable connection. In other words, the control device preferably does not contact the actuator outside the detachable connection. This allows heat transfer between the control device and the actuator to be minimized.

According to a development of the present invention, an air gap and/or a heat-insulating medium can be arranged between the control device and the coil. This prevents or at least further reduces heat transfer from the control device to the coil or from the coil to the control device.

According to a development of the present invention, the fastening means can have at least one screw-on tab (or one screw-on ear), in particular two screw-on tabs (or screw-on ears), for fastening to the unit by means of at least one screw, in particular by means of two screws. This allows the fastening means (and thus the control device) and the actuator to be easily and securely fastened to the unit. In particular, the (axial) end of the actuator facing the unit and/or the screw-on tab(s) contacts the unit without a gap. This allows heat transfer from the actuator to the unit and/or heat transfer from the fastening means (and therefore from the control device) to the unit to be maximized.

According to a development of the present invention, the control device can have a side which faces the coil and has a contact surface. The control device can contact the fastening means by means of the contact surface, in particular without a gap. The contact surface can represent (form) the largest part of the side facing the coil, in particular the entire side facing the coil, of the control device. This allows heat transfer from the control device to the fastening means to be maximized. In other words, the heat generated by the control device can be dissipated via the fastening means (toward the unit).

According to the present invention, a vehicle assembly comprising at least one unit and at least one actuator arrangement according to the present invention is provided. The actuator arrangement can be fastened to the unit, in particular screwed thereto.

With regard to the advantages that can be achieved therewith, reference is made to the corresponding statements relating to the actuator arrangement of the present invention. The measures described in connection with the actuator arrangement of the present invention and/or the measures explained below can serve for the further design of the vehicle assembly.

An example embodiment of the present invention will be explained below with reference to the figures.

### BRIEF DESCRIPTION OF THE DRAWINGS

FIG. 1 is a view of a front side of an actuator arrangement according to an example embodiment of the present invention.

FIG. 2 is a side view of the actuator arrangement according to FIG. 1.

FIG. 3 shows the actuator arrangement according to FIG. 2 and a unit, according to an example embodiment of the present invention.

FIG. 4 is a sectional view of the actuator arrangement according to FIG. 2.

### DETAILED DESCRIPTION OF EXAMPLE EMBODIMENTS

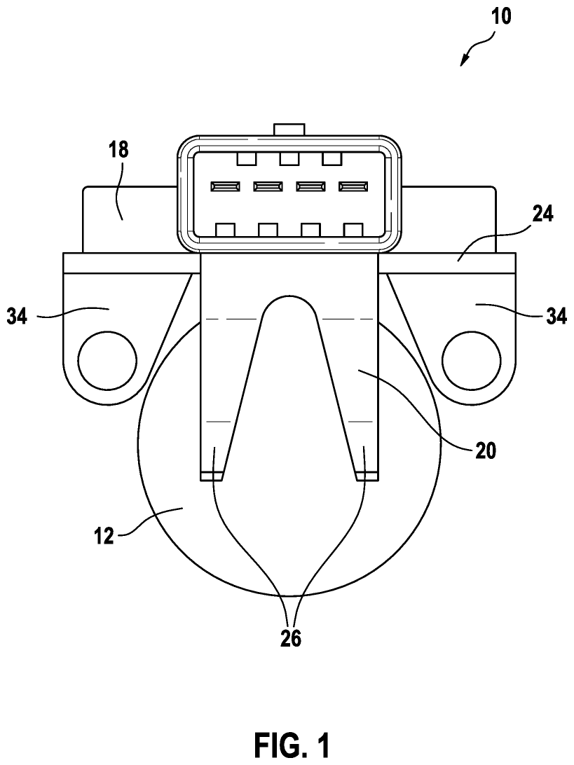

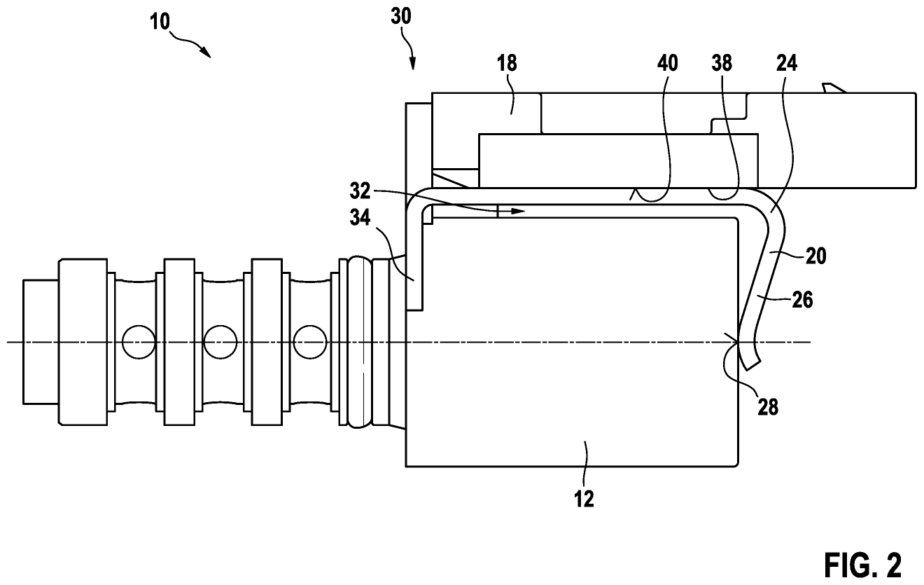

FIGS. 1 and 2 are a front view and a side view of an actuator arrangement 10, wherein the two views are oriented orthogonally to one another.

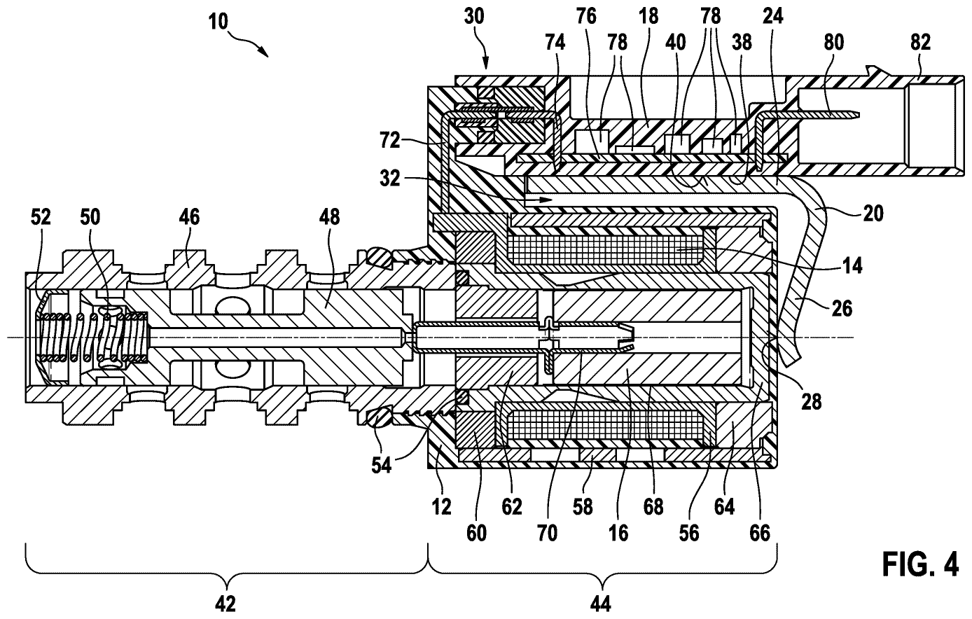

The actuator arrangement 10 has an electromagnetic actuator 12. The actuator 12 comprises an electrical coil 14 and an armature 16 which is mounted displaceably between a first position and a second position inside the coil 14, wherein the armature 16 can be moved from the first position to the second position by energizing the electrical coil 14 (cf. FIG. 4).

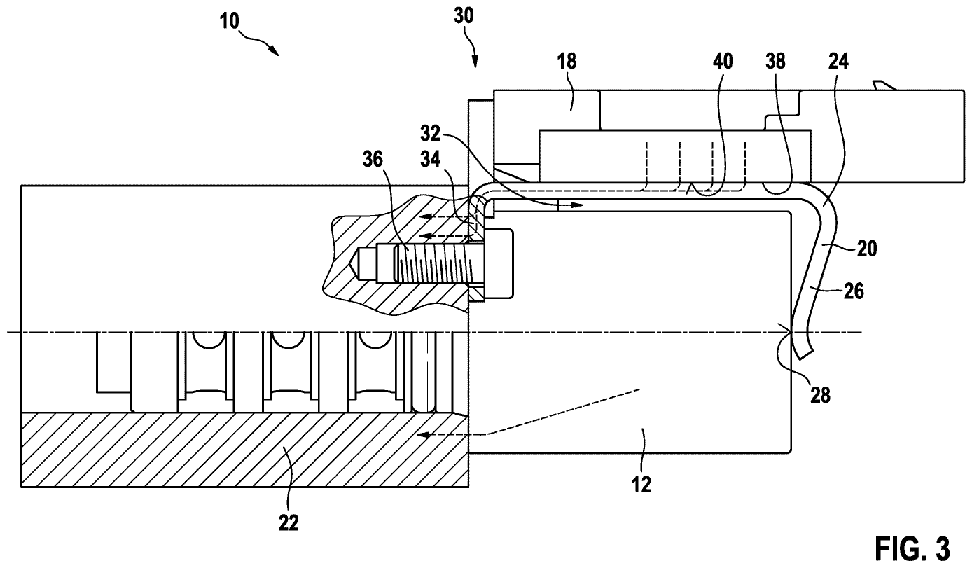

The actuator arrangement 10 has a control device 18 for controlling the actuator 12 and for energizing the electrical coil 14. The actuator arrangement 10 further comprises a fastening means (i.e., fastener) 20 for fastening the actuator 12 to a unit 22 (cf. FIG. 3).

In the present case, the fastening means 20 is designed in the form of a metal spring clip 24. The spring clip 24 has two spring arms 26 (cf. FIGS. 1 and 2). The spring clip 24 has a contact surface 28 by means of which the spring clip 24 contacts the actuator 12. In the present case, the contact surface 28 on the two spring arms 26 is designed in the form of two spatially separated partial regions (one partial region per spring arm 26).

The control device 18 is connected to the actuator 12 by means of a detachable connection 30. The control device 18 has a side 38 which faces the coil 14 and has a contact surface 40. The control device 18 is arranged on the spring clip 24 and contacts it without a gap by means of the contact surface 40.

An air gap 32 is arranged between the spring clip 24 (and therefore the control device 18) and the actuator 12 (and therefore the coil 14). The spring clip 24 has two screw-on tabs 34, each of which serves for fastening to the unit 22 by means of a screw 36 (cf. FIGS. 1 and 3).

FIG. 3 shows the actuator arrangement 10 according to FIG. 2 and the unit 22. The actuator arrangement 10 is screwed to the unit 22 by means of two screws 36. The spring arms 26 of the spring clip 24 press the actuator 12 against the unit 22 so that the actuator 12 rests against the unit 22 at its end facing the unit 22 or at its front side facing the unit 22 without a gap (or contacts the unit 22 without a gap). The unit 22 is shown only schematically in FIG. 3. The unit 22 represents a heat sink for the actuator arrangement 10. In FIG. 3, a plurality of heat transfer paths are shown by arrows.

The heat generated by the control device 18 is transferred to the spring clip 24 via the contact surface 40. The heat then flows via the spring clip 24 and the screw-on tabs 34 of the spring clip 24 into the unit 22. This heat transfer path is indicated by arrows in FIG. 3.

The heat generated by the coil 14 of the actuator 12 is transferred directly to the unit 22 (via the contact surface between the actuator 12 and the unit 22). This heat transfer path is indicated by an arrow in FIG. 3.

As can be seen from the heat transfer paths indicated by arrows, heat transfer between the control device 18 and the actuator 12 (or the coil 14 of the actuator 12) is prevented or at least reduced.

FIG. 4 is a sectional view of the actuator arrangement 10 according to FIG. 2. The actuator 12 has a hydraulic region 42 and an electromagnetic region 44. The hydraulic region 42 of the actuator 12 comprises a valve housing 46 in which a valve piston 48 is displaceably mounted. The valve piston 48 is preloaded in the direction of the electromagnetic region 44 of the actuator 12 (to the right in FIG. 4) by means of a return spring 50 which is mounted in a spring bearing 52 of the valve housing 46.

The hydraulic region 42 and the electromagnetic region 44 of the actuator 12 are sealed by means of two O-rings 54.

The electromagnetic region 44 of the actuator 12 comprises the coil 14, which is embedded in a coil body 56 and arranged within a magnet housing 58. The magnet housing 58 is in this case cylindrical and has a flux disk 60 having a magnetic core 62 at its first axial end (facing the hydraulic region 42). The magnet housing 58 has a magnetic disk 64 at its second axial end, opposite the first axial end.

A pole tube 66 is arranged in the electromagnetic region 44 of the actuator 12, which pole tube is arranged inside the coil 14, the magnetic disk 64 and the flux disk 60. The magnetic core 62 is arranged inside the pole tube 66. The armature 16 is also mounted displaceably in the pole tube 66. A bearing film 68 is arranged between the armature 16 and the pole tube 66. The armature 16 is connected to the (preloaded) valve piston 48 of the hydraulic region 42 of the actuator 12 by means of an operating pin 70.

The return spring 50 pushes the valve piston 48 to the right in FIG. 4. As a result, the armature 16 is also pushed to the right in FIG. 4 via the operating pin 70 (first position of the armature 16). If the coil 14 is now energized, the armature 16 is moved to the left in FIG. 4 due to magnetic interaction (against the spring force of the return spring 50) (second position of the armature 16). If the energization of the coil 14 is interrupted (deactivated), the force which moves the armature into the second position due to the magnetic interaction ceases so that the armature 16 is moved back into the first position by means of the return spring 50.

The actuator 12 has a plurality of first contact pins 72 and the control device 18 has a plurality of second contact pins 74. The first contact pins 72 and the second contact pins 74 are each electrically connected to one another at the detachable connection 30 of the actuator arrangement 10. The control device 18 has a printed circuit board 76 on which a plurality of electronic components 78 and the second contact pins 74 are arranged. The control device 18 has a plurality of third contact pins 80 which are arranged on the printed circuit board 76 and protrude into a plug connection 82.

A battery voltage and a control signal (BUS signal) can be transmitted to the control device 18 via the plug connection 82 and the third contact pins 80. A voltage (or an actuating current) for energizing the coil 14 can be supplied to the actuator 12 via the second contact pins 74 and the first contact pins 72.

1-10. (canceled)

11. An actuator arrangement to be fastened to a unit, comprising:
an electromagnetic actuator including at least one electrical coil and at least one one armature which is mounted displaceably between a first position and a second position inside the coil, wherein the armature is configured to be moved from the first position to the second position by energizing the electrical coil;
a control device configured to control the electromagnetic actuator for energizing the electrical coil; and
a fastener configured to fasten the electromagnetic actuator to the unit, wherein the control device is arranged on the fastener.

12. The actuator arrangement according to claim 11, wherein the fastener is a metal spring clip.

13. The actuator arrangement according to claim 12, wherein the spring clip has at least one spring arm for contacting the actuator.

14. The actuator arrangement according to claim 11, wherein the fastener has a contact surface and contacts the actuator exclusively via the contact surface, wherein the contact surface is smaller than 10mm².

15. The actuator arrangement according to claim 11, wherein the fastener and the control device are configured as an assembly.

16. The actuator arrangement according to claim 11, wherein the control device is connected to the actuator via a detachable connection, including a snap-in clip and/or plug connection.

17. The actuator arrangement according to claim 11, wherein an air gap and/or a heat-insulating medium is arranged between the control device and the coil.

18. The actuator arrangement according to claim 11, wherein the fastener has at least one screw-on tab configured to fasten to the unit via at least one screw.

19. The actuator arrangement according to claim 11, wherein the control device has a side which has a contact surface and faces the coil, wherein the control device contacts the fastener via the contact surface, wherein the contact surface forms a largest part of a side facing the coil, of the control device.

20. A vehicle assembly, comprising:
at least one unit; and
at least one actuator arrangement including:
an electromagnetic actuator including at least one electrical coil and at least one one armature which is mounted displaceably between a first position and a second position inside the coil, wherein the armature is configured to be moved from the first position to the second position by energizing the electrical coil,
a control device configured to control the electromagnetic actuator for energizing the electrical coil, and
a fastener configured which fastens the electromagnetic actuator to the unit, wherein the control device is arranged on the fastener.
